(19) United States
(12) Patent Application Publication
(10) Pub. No.: US 2013/0013340 A1
(43) Pub. Date: Jan. 10, 2013

(54) Wellness Decision Support Services

(75) Inventors: Mark J.H. Hsiao, Sindian City (TW); Pei-yun S. Hsueh, Hawthorne, NY (US); Sreeram Ramakrishnan, Yorktown Heights, NY (US); Liangzhao Zeng, Mohegan Lake, NY (US)

(73) Assignee: International Business Machines Corporation, Armonk, NY (US)

(21) Appl. No.: 13/614,189

(22) Filed: Sep. 13, 2012

Related U.S. Application Data
(63) Continuation of application No. 13/153,673, filed on Jun. 6, 2011.

(51) Int. Cl. G06Q 50/22

(52) U.S. Cl. 705/3

(57) ABSTRACT

Techniques for providing one or more user-centric wellness decision support services are provided. The techniques include providing an interface that facilitates selection of a risk assessment model of interest for a user and an action plan to trigger one or more follow-up action items, applying the selected model to assess the user's wellness risk level based on one or more user wellness records, and applying the selected action plan to trigger one or more relevant disease management and lifestyle interventions.

### CROSS-REFERENCE TO RELATED APPLICATIONS

This application is a continuation of U.S. patent application Ser. No. 13/153,673, filed Jun. 6, 2011, incorporated by reference herein.

### FIELD OF THE INVENTION

Embodiments of the invention generally relate to information technology, and, more particularly, to health management.

### BACKGROUND OF THE INVENTION

The prevalence of lifestyle-related health problems poses a grand challenge to national health systems. For example, structured lifestyle intervention on controlling health risks can be effective, but the implementation of such user-centric plans can quickly drain out resources.

Dynamically forming wellness service ecosystems to offer personalized lifestyle intervention plans also exist. However, while existing providers keep expanding service choices to cover various user needs, there is still a long tail of demand unsatisfied, such as, for example, the ability to infer wellness needs and adjust interventions accordingly.

Additionally, existing approaches often provide a rigid system design that limits the reusability, composibility, and accessibility of the components. As a result, the existing systems do not facilitate individuals with self-assessment capabilities or control over an individual wellness management process. Also, existing approaches do not fully utilize risk models.

### SUMMARY OF THE INVENTION

Principles and embodiments of the invention provide techniques for wellness decision support services. An exemplary method (which may be computer-implemented) for providing one or more user-centric wellness decision support services, according to one aspect of the invention, can include steps of providing an interface that facilitates selection of a risk assessment model of interest for a user and an action plan to trigger one or more follow-up action items, applying the selected model to assess the user's wellness risk level based on one or more user wellness records, and applying the selected action plan to trigger one or more relevant disease management and lifestyle interventions.

One or more embodiments of the invention or elements thereof can be implemented in the form of a computer product including a tangible computer readable storage medium with computer useable program code for performing the method steps indicated. Furthermore, one or more embodiments of the invention or elements thereof can be implemented in the form of an apparatus including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s), or (iii) a combination of hardware and software modules; any of (i)-(iii) implement the specific techniques set forth herein, and the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating risk-driven wellness decision support architecture, according to an embodiment of the present invention;

FIG. 2 is a diagram illustrating example steps for risk-driven wellness decision support, according to an embodiment of the present invention;

FIG. 3 is a diagram illustrating a user model acquisition module and personalization framework, according to an embodiment of the present invention;

FIG. 4 is a diagram illustrating an example system design for risk-driven wellness decision, according to an embodiment of the present invention;

FIG. 5 is a chart illustrating system-level components, according to an embodiment of the present invention;

FIG. 6 is a flow diagram illustrating techniques for providing one or more user-centric wellness decision support services, according to an embodiment of the invention; and

FIG. 7 is a system diagram of an exemplary computer system on which at least one embodiment of the invention can be implemented.

### DETAILED DESCRIPTION OF EMBODIMENTS

Principles of the invention include risk-driven wellness decision support services. As detailed herein, one way to help overcome “treatment inertia” (that is, the inclination of human beings to resist change) is to allow the users to perform self-assessment on wellness risks and find suitable life intervention plans accordingly. In one or more embodiments of the invention, the development of a wellness decision support tool involves at least the tasks of applying risk models to infer a person's wellness status, and, given the wellness risk assessment, following the wellness guidelines to select suitable lifestyle intervention plans.

Also, one or more embodiments of the invention include designing a wellness cloud that is a dynamic infrastructure pattern that follows service-oriented approaches to facilitate the collaboration among wellness service providers and independent software vendors (ISVs). On top of the wellness services can be provided to develop a configurable wellness decision service engine, where service providers, with permission from the user, can plug-in various wellness evidences to provide personalized services.

Additionally, one or more embodiments of the invention include components such as storage of a patient's health profile (for example, previous lab exam results), expert-provided guideline for health promotion (for example, exercise routines or dietary plans), connection to a specific brand of monitoring devices for direct download, and connection to clinical experience (for example, clinical visit calendar).

As described herein, a wellness decision support system uses a statistical engine to perform remote wellness knowledge application, and can also complement a patient similarity engine to perform collaborative filtering as the foundation of any personalization service.

As further detailed herein, one or more embodiments of the invention can include the following aspects. To address the challenge of wellness knowledge reusability, a knowledge manager is used that handles the publish/subscribe (pub/sub) mechanism of wellness knowledge (which can be stored in the international predictive model markup language (PMML) standard) and allows joint analysis, such that models can be applied on the fly to datasets of different parties. To address the challenge of wellness decision service accessibility and composibility, a user-configurable wellness decision services is used in which a user can specify the model and guideline of interest in the wellness knowledge repository and apply them on his or her own wellness records for assessment and action. Also, for the users/developers who are not domain experts, one or more embodiments can also include a configure-free module, which can interactively solicit user models (that is, wellness management goal and perceived importance of risk factors) from user input and select the most relevant action plans according to the learned user model.

Additionally, one or more embodiments of the invention can also include a platform that is equipped with connections to personal wellness record databases and analytics capabilities of bootstrapping the processing of personal wellness risk profiling from examples, saving users from the high entry barrier of manual input. Also, a context-awareness component can be include that integrates contextual information, which is collected from smart sensors (for example, activity type, location, social network status) and users in the loop to infer personal wellness status (that is, how the patient is). Further, a personalized continuous feedback loop mechanism can also be included that can update a current status and recommended services with respect to changes revealed in the monitoring context.

In one or more embodiments of the invention, parameters can be configured to include the types of health risk and the factors a user wants to control. The configured service can then analyze the risk factors underlying the selected types of risk models and compare their risk levels with the selected population group with which to compare. If no population group is selected, a subset of users who are the most similar to a particular user's wellness history can be selected for comparison.

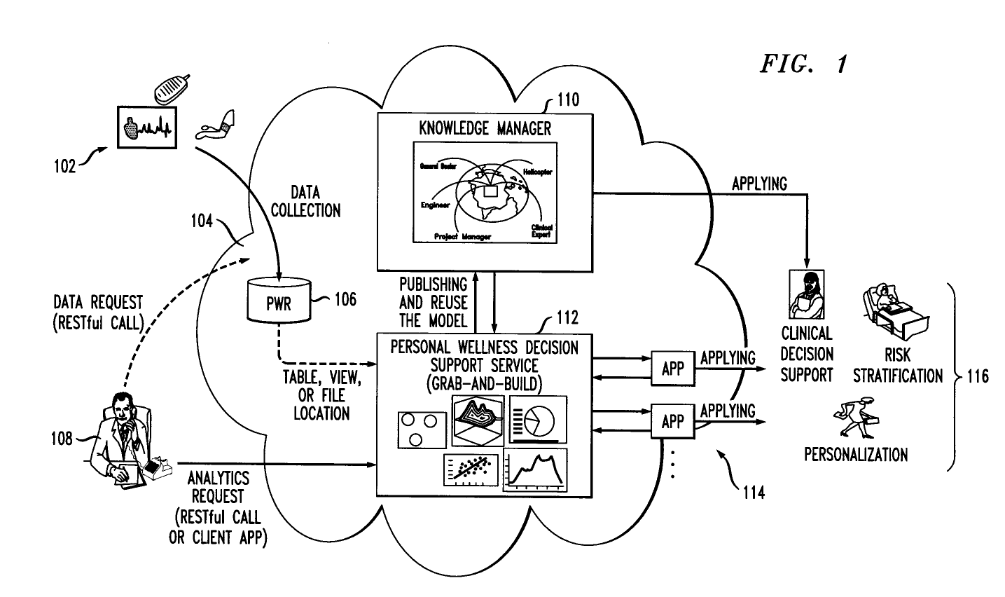

FIG. 1 is a diagram illustrating risk-driven wellness decision support architecture, according to an embodiment of the present invention. By way of illustration, FIG. 1 depicts a user device 102, a data collection network 104, a personal wellness record (PWR) 106, a data request component 108, a knowledge manager component 110, a personal wellness decision support component 112, application components 114 and output components (for example, clinical decision support, risk stratification, personalization, etc.) 116.

As illustrated in FIG. 1, one or more embodiments of the invention include the feature of reusable domain knowledge. Domain experts or vendors can upload risk assessment models and follow-up action plans for others to use. Additionally, one or more embodiments of the invention include configuring a wellness decision service. As depicted in FIG. 1, users can select any given model from the repository to apply on their own wellness records for assessment.

One or more embodiments of the invention, as noted herein, can also include the feature of a configure-free module. For those who do not know which model or action plan to choose, service providers can invoke the configure-free module to solicit input from healthcare professionals and users so as to select suitable actions accordingly at the point of wellness care.

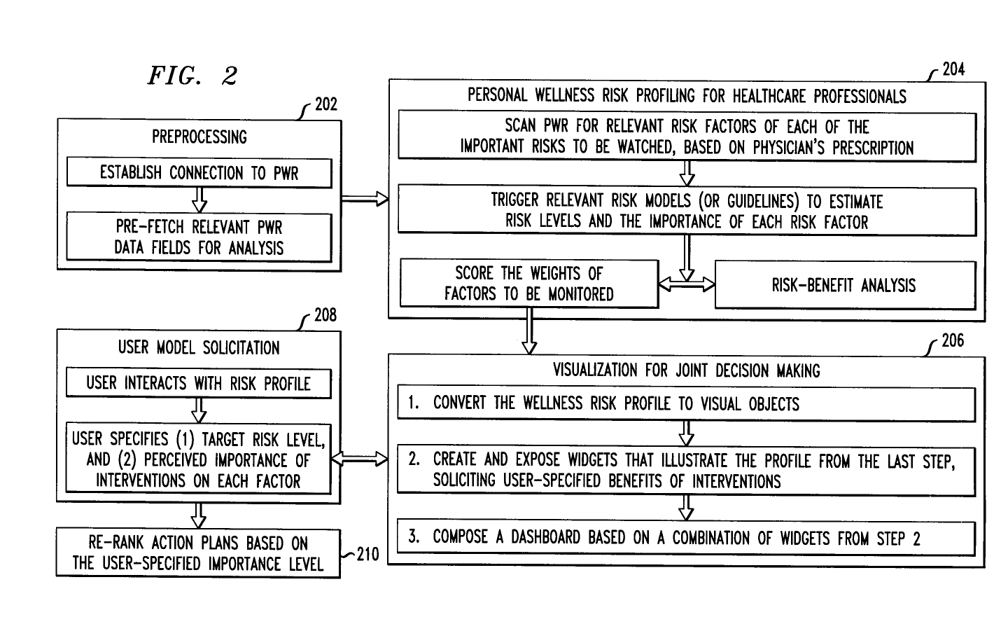

FIG. 2 is a diagram illustrating example steps for risk-driven wellness decision support, according to an embodiment of the present invention. By way of illustration, FIG. 2 depicts preprocessing steps 202, personal wellness risk profiling for healthcare professionals steps 204, visualization for joint decision making steps 206 and user model solicitation steps 208. Preprocessing steps 202 include establishing connection to PWR and pre-fetching relevant PWR data fields for analysis. Personal wellness risk profiling for healthcare professionals steps 204 include scanning PWR for relevant risk factors of each important risk to be watched (based, for example, on a physician's prescription), triggering relevant risk models (or guidelines) to estimate risk levels and the importance of each risk factor, performing a risk-benefit analysis and scoring the weights of factors to be monitored.

As also detailed in FIG. 2, visualization for joint decision making steps 206 include converting the wellness risk profile to visual objects, creating and exposing widgets that illustrate the profile from the last step, soliciting user-specified benefits of interventions, and composing a dashboard based on a combination of widgets. Additionally, user model solicitation steps 208 include user interaction with the risk profile and user specification of a target risk level and a perceived importance of interventions on each factor. Further, step 210 includes re-ranking action plans based on the user-specified importance level.

Accordingly, a user identifies important risks and factors for wellness decisions and the system of one or more embodiments of the invention configures the decision service to invoke suitable action plans. The system selects the action plans that have interventions on matching risk factors to those in the solicited user model (that is, the perceived importance levels of the factors and interventions), and the system ranks these selected action plans based on, for example, simplified additive multi-attribute value functions, using either one of the following two strategies.

One strategy includes an information-based rating, which includes ranking action plans with respect to the user model. For example, the importance level of an action plan is the weighted average of factor importance:

$$imp ( {u}_{a} , {ap}_{t} ) = {\sum }_{{f}_{i} ∈ {ap}_{t}} {w}_{{f}_{i}}^{′} imp ( {u}_{a} , {f}_{i} )$$

$${w}_{{f}_{i}}^{′} = {w}_{{f}_{i}} \div {\sum }_{i = 1}^{n} {w}_{{f}_{i}}$$

Another strategy includes collaborative rating, which includes ranking action plans with respect to the models of users in the same risk group. For example, the importance level of a factor is determined by the average of importance ratings reweighted by the similarity to the user:

$$imp ( {u}_{a} , {f}_{i} ) = \frac{{\sum }_{n ∈ N} sim ( {u}_{a} , {u}_{n} ) imp ( {u}_{n} , {f}_{i} )}{{\sum }_{n ∈ N} sim ( {u}_{a} , {u}_{n} )}$$

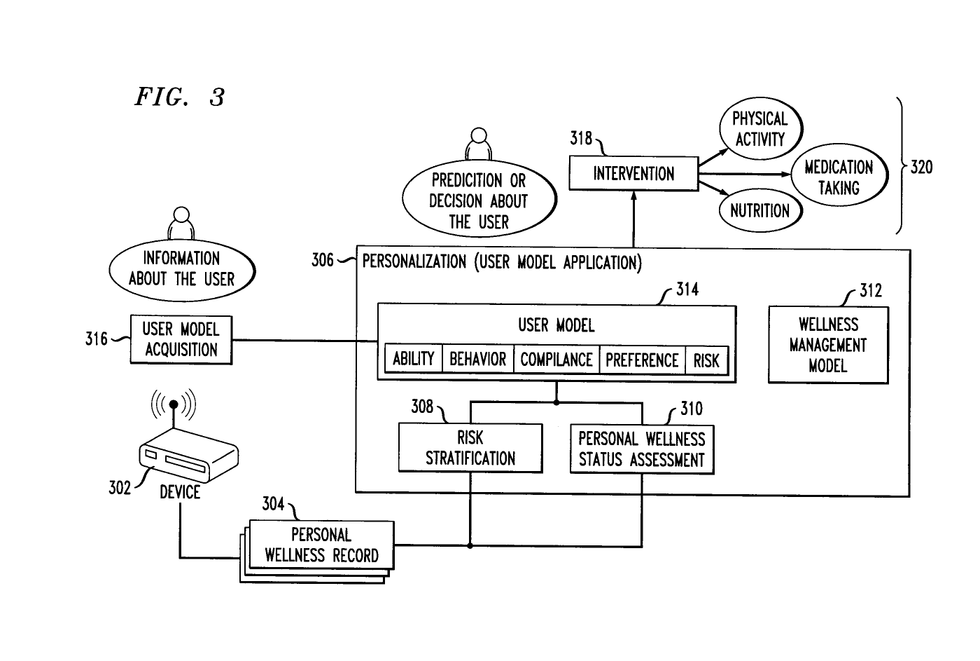

FIG. 3 is a diagram illustrating a user model acquisition module and personalization framework, according to an embodiment of the present invention. By way of illustration, FIG. 3 depicts a device 302, a personal wellness record 304, a personalization module 306 which includes a risk stratification component 308, a personal wellness status assessment component 310, a wellness management model 312 and a user model 314. FIG. 3 also depicts a user model acquisition component 316, an intervention component 318 and additional information components 320 (for example, physical activity, nutrition, medication taking, etc.).

As illustrated in FIG. 3, a user can identify the perceived importance to wellness decisions, (for example, with respect to fat, carbohydrate, protein, cholesterol, fiber, etc. intake) as detailed in one of the examples described herein. Accordingly, as depicted in FIG. 3, the personalization engine can select the relevant attributes from a user model to make a prediction of the user's wellness status as well as make follow-up recommendations. If there are some attributes missing from the user model that are essential for prediction and recommendation, the engine will solicit those attributes from the user.

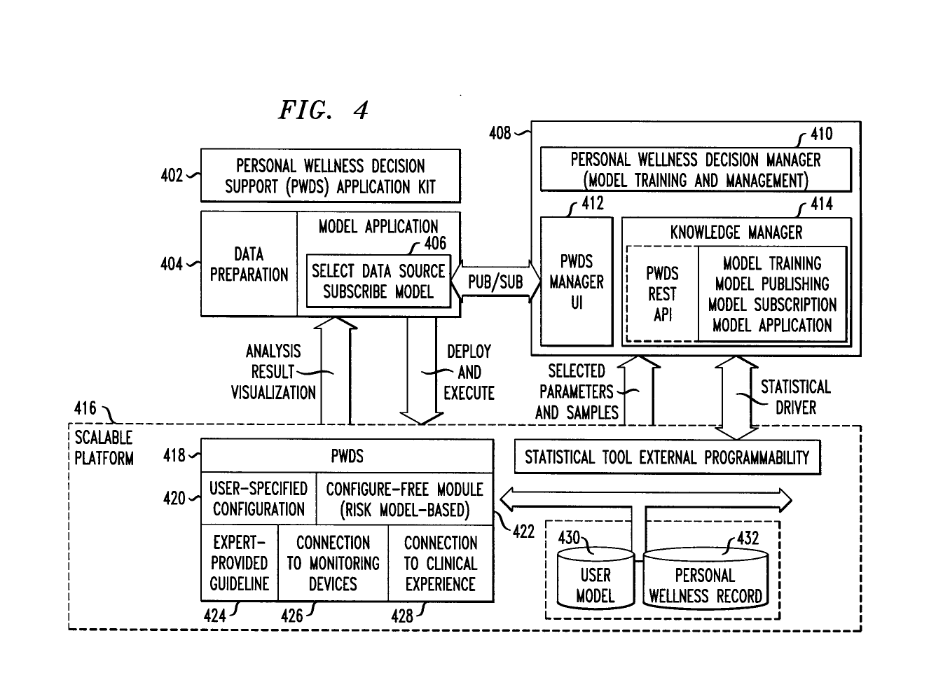

FIG. 4 is a diagram illustrating an example system design for risk-driven wellness decision, according to an embodiment of the present invention. By way of illustration, FIG. 4 depicts a personal wellness decision support (PWDS) application kit 402, a data preparation component 404, a model application component 406, and component 408 which includes a personal wellness decision manager component 410, PWDS manager user interface (UI) 412 and a knowledge manager component 414. FIG. 4 also depicts a scalable platform 416, which includes a PWDS component 418, a user-specified configuration component 420, a configure-free module 422, an expert-provided guideline component 424, a connection 426 to monitoring devices, a connection 428 to clinical experience, a user model 430 and a personal wellness record 432.

In connection with the personal wellness decision support (PWDS) manager 412, when the user knows what to choose, the flow of data can continue to user configuration. When the user does not know what to choose, the configure-free module can be triggered as follows. A dashboard of risk profiles and widgets is provided to display impacts of interventions. Also, feedback is solicited from user to construct user models (that is, target risk and the perceived benefits of interventions on different risk factors). As such, risk action plans are selected based on an information-based/collaborative filtering strategy. Additionally, one or more embodiments of the invention can include an auto scale-in/scale-out mechanism implemented to determine how many instances are needed for current personalization task.

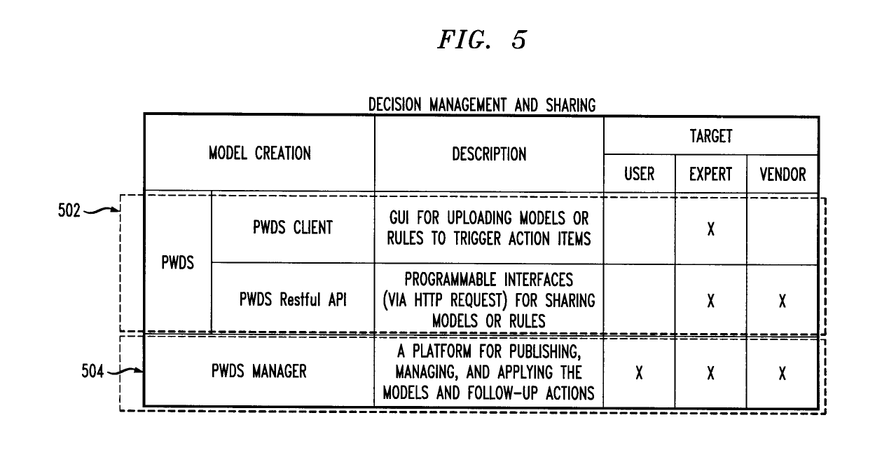

FIG. 5 is a chart illustrating system-level components, according to an embodiment of the present invention. By way of illustration, FIG. 5 depicts a model creation portion 502 and a decision management and sharing portion 504. FIG. 5 describes who the likely users of each component are. For example, a user can use the manager to learn his or her health risk and select follow-up action plans accordingly, using the dynamically generated widget and feedbacks on different interventions. The expert can use PWDS to create or upload new risk models. Also, the vendor can subscribe to different models the experts have created and stored in the knowledge repository. Additionally, the vendor can consequently generate new wellness-related services for target users based on these learned models.

An example of applying risk-driven personalization on the selection of proper nutrition intake plans for diabetic users can include the following (for illustration purposes). Jane, a diabetic patient, has been using a wellness management portal to manage her disease. Her physical examination center has just notified her that her annual check-up report is now ready online. She logged-in to see the report and discovered some problem areas and likely complications (such as, for instance, hypoglycemia episodes) in the physician's note. As she wants to understand a bit more, she enters the risk profiling section.

Accordingly, one or more embodiments of the invention can go through her personal wellness history (including the new physical exam results) to extract features that are related to the problem areas diagnosed by the physician. Also, the system analyzes the risk level of the problem areas using the extracted features and shows a chart to the user that illustrates the problem areas, links each of the problem areas to its likely sources of problem and calculates the importance level of each factor.

Additionally, the user's risk profile can be used to trigger suggestions of follow-up disease management and lifestyle interventions (for example, daily nutrition intake composition) based on national guidelines (or the guidelines prescribed by the physician). In this example case, the user has a high risk of dyslipidemia (specifically, hyper-lipidemia), therefore a special diet intervention is recommended to lower total cholesterol (TC) and LDL cholesterol (LDL-C) concentrations. The national guideline suggests the daily nutrition composition under such risk as follows: fat ≦30%; carbohydrate 50-60%; protein 10-20%; total cholesterol ≦300 mg; fiber 25-35 mg. Going through Jane's blood glucose (BG) monitoring records, one or more embodiments of the invention can also find that the low-fat, high-carb meals are not helping Jane prevent hypoglycemia episodes.

Following up on the requirement of the guidelines, there are several options of diet planning available that can meet the requirement. The configuration-free module of one or more embodiments of the invention can then be invoked to learn the dietitian's opinions on Jane's conditions and Jane's own preferences. First, the acquisition module is invoked to learn the dietitian's opinions on Jane's conditions and Jane's own preferences. She chooses the coronary heart disease (CHD) risk as the target outcome to be improved and uses the dashboard and widgets to visualize what interventions can help reduce the risk. After interacting with the system, she answers questions of the benefits of the different interventions.

| | 0 worst | | | ideal 1.0 |
|---|---|---|---|---|
| Fat | excessive (0) | Med (0.3) | Low (0.9) | none (1.0) |
| Carb | excessive (0) | High (0.5) | Med (0.7) Low (0.8) | none (1.0) |
| Protein | Low (0) | excessive (0.7) | High (0.9) | Med (1.0) |
| Cholesterol | excessive (0) | High (0.2) | Med (0.8) | Low (1.0) |
| Fiber | excessive (0) | High (0.3) | Low (0.4) | Med (1.0) |

One or more embodiments of the invention can then score the action plans with respect to the solicited user model (that is, the perceived importance levels of the factors and interventions).

| | Meal Plan 1 | Meal Plan 2 | Meal Plan 3 |
|---|---|---|---|
| Fat | Low 0.9 | None 1.0 | High 0.3 |
| Carb | Low 0.8 | Med 0.7 | High 0.5 |
| Protein | excessive 0.7 | High 0.9 | Med 1.0 |
| Cholesterol | High 0.2 | Med 0.8 | Low 1.0 |
| Fiber | High 0.3 | Med 1.0 | Low 0.4 |

For each adaptation (modification and insertion) the adjustment module applies, the system will check if the adapted plan is feasible. Once all of the available diet plans are adjusted, the ranker module can be invoked to score the multiple adjusted plans so that these plans can be displayed in the order of preference. One or more embodiments of the invention can rank these selected action plans based on a simplified additive multi-attribute value function, such as the information-based rating described herein.

recommends Meal Plan 2

| | FAT | CARB | PRO | CHOL | FIBER | TOTALS |
|---|---|---|---|---|---|---|
| Weights | 0.38 | 0.26 | 0.16 | 0.12 | 0.08 | |
| Importance | | | | | | |
| scores: | | | | | | |
| Meal Plan 1 | 0.9 | 0.8 | 0.7 | 0.2 | 0.3 | 0.710 |
| Meal Plan 2 | 1.0 | 0.7 | 0.9 | 0.8 | 1.0 | 0.826 |
| Meal Plan 3 | 0.3 | 0.5 | 0.1 | 0.1 | 0.4 | 0.304 |

Based on the personal nutrition need and preferences, when dining out, the smart nutrition system will personalize the recommendation scoring of each dish on the menu. For example, foods that come with higher proportion of non-starchy vegetables and low-carb fruits (such as berries) will be scored higher for Jane. In addition, one or more embodiments of the invention also receive feedbacks from Jane and use the feedback to update recommendations. The information-based strategy is combined with the collaborative filtering that can learn from a control group.

When system developers know what disease risk models and comorbidity index to incorporate into a user's wellness decision support, they can, for example, use a knowledge manager component to check in the wellness knowledge repository of pertinent risk models, and use the configuration interface of wellness decision services to apply the pertinent risk models on incoming user data.

When system developers do not know what to incorporate, they can invoke the configure-free module, as detailed herein, to learn user models. Developers can then configure the decision services with the learned pertinent risk models and importance risk factors.

Accordingly, the configured wellness decision service can be deployed to users in situations, such as, for example, each time a new user comes in, his/her wellness profile will be created, and when s/he returns the next time, his/her profile will be updated with the changes of risk factors identified through monitoring data.

One or more embodiments of the invention also include a simplified additive multi-attribute value function with collaborative filtering. This provides a workable means to implement the principles of risk-based personalized decision support. Also, it can be more accurate than guideline-based decision support (more realistic scores, tradeoffs, etc.), and can identify interventions, specify perceived benefits over interventions, identify alternative action plans available and measure scores, as well as provide a simple calculation by additive functions and collaborative filtering algorithms.

Accordingly, as detailed herein, one or more embodiments of the invention can provide a personal wellness status assessment (using the past to infer current status). Given the selected risk models from the repository, the system can profile the current wellness status of a user given his/her wellness record. Additionally, one or more embodiments can provide personalized lifestyle intervention recommendations (understanding current status and context). Given the selected risk models and lifestyle intervention plan, the system can trigger the suitable follow-up actions based on wellness records.

Dynamic service delivery (understanding changes) can also be provided, in that given the changes in the wellness record, the wellness decision support can update the user wellness profile accordingly. Further, one or more embodiments of the invention additionally include micropayment provisioning (understanding contribution). As the knowledge manager logs how the risk models and plans are used by other services, the system can help develop a micro-payment provisioning mechanism.

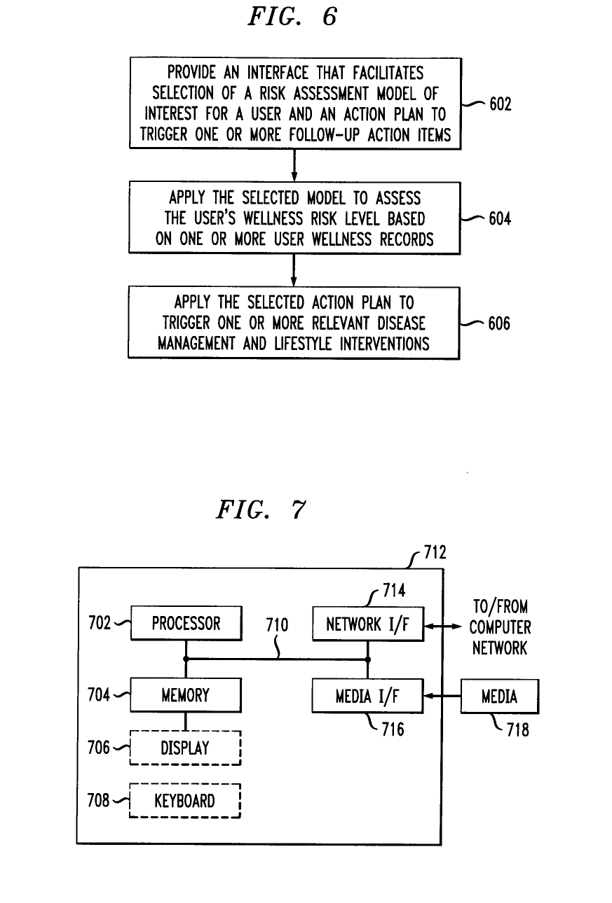

FIG. 6 is a flow diagram illustrating techniques for providing one or more user-centric wellness decision support services, according to an embodiment of the present invention. Step 602 includes providing an interface that facilitates selection of a risk assessment model of interest for a user and an action plan to trigger one or more follow-up action items. This step can be carried out, for example, using a personal wellness decision configuration interface. Providing an interface further facilitates selection of a target population group with which to compare a personal risk level.

In one or more embodiments of the invention, selection of the risk assessment model can be carried out by the healthcare professional (or, for example, a case managers or the user) who work with the service vendors to select the risk assessment model. The user can play with the widget (provided by one or more embodiments of the invention) to understand the consequence of different interventions on the various types of risks being analyzed. Accordingly, one or more embodiments of the invention provide flexibility of model selection on the vendor side, as well as the benefit for the users to select intervention plans based on both health-professional prescribed assessment model and their own preferences.

Step 604 includes applying the selected model to assess the user's wellness risk level based on one or more user wellness records. This step can be carried out, for example, using a risk stratification engine.

Step 606 includes applying the selected action plan to trigger one or more relevant disease management and lifestyle interventions. This step can be carried out, for example, using a personalized recommendation engine. Applying the selected model to assess the user's wellness risk level based on one or more user wellness records further includes assessing the user's wellness risk level based on records from the selected target population group.

The techniques depicted in FIG. 6 also include using a personal wellness knowledge manager to maintain a wellness knowledge repository. The knowledge repository can be used in connection with the models that describe what user attributes are to be used in analyzing a particular type of risk and in what fashion (for example, weighting). One or more embodiments of the invention can also include using a personal wellness decision support client to facilitate sharing of disease management and lifestyle intervention action plans (for example, rules for exercise therapy or nutrition intakes) in an online knowledge repository. Also, a wellness decision service deployment module can be used to analyze input from a knowledge repository (for example, an input disease management plan or related guidelines) and one or more restrictions and constraints in a user risk profile, and output an adjusted plan.

The techniques depicted in FIG. 6 also include providing a configuration-free module for use if there is no user selection of a risk assessment model of interest and an action plan. The configuration-free module solicits input from one or more healthcare professionals and one or more users. Also, the configuration-free module includes an automatic profiling module that constructs a user's wellness profile by scanning through one or more user wellness records and identifying one or more risk factors. Additionally, the configuration-free module includes a user model solicitation interface that facilitates interaction with the user for input of one or more wellness management goals and risk factor importance. Further, the configuration-free module includes a configuration facilitation module that identifies one or more pertinent risk models and associated risk factors and ranks one or more relevant action plans.

Ranking relevant action plans can include information-based filtering by matchmaking a description of each action plan to one or more user records and aggregating an importance level rating of one or more involved risk factors (for example, via:

$$imp ( {u}_{a} , {ap}_{t} ) = {\sum }_{{f}_{i} ∈ {ap}_{t}} {w}_{{f}_{i}}^{′} imp ( {u}_{a} , {f}_{i} ) \\ {w}_{{f}_{i}}^{′} = {w}_{{f}_{i}} \div {\sum }_{i = 1}^{n} {w}_{{f}_{i}} ) .$$

Also, ranking relevant action plans can include collaborative filtering by aggregating an importance level rating of each risk factor from one or more users who have a similar wellness history to the user in question (for example, via:

$$imp ( {u}_{a} , {f}_{i} ) = \frac{{\sum }_{n ∈ N} sim ( {u}_{a} , {u}_{n} ) imp ( {u}_{n} , {f}_{i} )}{{\sum }_{n ∈ N} sim ( {u}_{a} , {u}_{n} )} ) .$$

Additionally, one or more embodiments of the invention include using a wellness decision service deployment module to analyze input from a knowledge repository (for example, an input disease management plan or related guidelines) and one or more restrictions and constraints in a user risk profile, and output an adjusted plan. Further, the techniques depicted in FIG. 6 can include facilitating a vendor to subscribe to one or more models (created by experts) stored in a knowledge repository and new wellness-related services for target users based on the learned models.

The techniques depicted in FIG. 6 can also, as described herein, include providing a system, wherein the system includes distinct software modules, each of the distinct software modules being embodied on a tangible computer-readable recordable storage medium. All the modules (or any subset thereof) can be on the same medium, or each can be on a different medium, for example. The modules can include any or all of the components shown in the figures. In one or more embodiments, the modules include a personal wellness decision configuration interface module, a risk stratification engine module and a personalized recommendation engine module that can run, for example on one or more hardware processors. The method steps can then be carried out using the distinct software modules of the system, as described above, executing on the one or more hardware processors. Further, a computer program product can include a tangible computer-readable recordable storage medium with code adapted to be executed to carry out one or more method steps described herein, including the provision of the system with the distinct software modules.

Additionally, the techniques depicted in FIG. 6 can be implemented via a computer program product that can include computer useable program code that is stored in a computer readable storage medium in a data processing system, and wherein the computer useable program code was downloaded over a network from a remote data processing system. Also, in one or more embodiments of the invention, the computer program product can include computer useable program code that is stored in a computer readable storage medium in a server data processing system, and wherein the computer useable program code are downloaded over a network to a remote data processing system for use in a computer readable storage medium with the remote system.

Further, in one or more embodiments of the invention, the techniques depicted in FIG. 6 can be implemented via instantiation of program code in a system engine, where the description can be translated into a computable program to make inference from the input data.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. With reference to FIG. 7, such an implementation might employ, for example, a processor 702, a memory 704, and an input/output interface formed, for example, by a display 706 and a keyboard 708. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 702, memory 704, and input/output interface such as display 706 and keyboard 708 can be interconnected, for example, via bus 710 as part of a data processing unit 712. Suitable interconnections, for example via bus 710, can also be provided to a network interface 714, such as a network card, which can be provided to interface with a computer network, and to a media interface 716, such as a diskette or CD-ROM drive, which can be provided to interface with media 718.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 702 coupled directly or indirectly to memory elements 704 through a system bus 710. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 708, displays 706, pointing devices, and the like) can be coupled to the system either directly (such as via bus 710) or through intervening I/O controllers (omitted for clarity).

Network adapters such as network interface 714 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 712 as shown in FIG. 7) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 718 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, component, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components shown in the figures and corresponding descriptions detailed herein. The method steps can then be carried out using the distinct software modules and/or sub-modules of the system, as described above, executing on one or more hardware processors 702. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

At least one embodiment of the invention may provide one or more beneficial effects, such as, for example, providing a configure-free module that can interactively solicit user models from user input and select the most relevant action plans according to a learned user model.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art.

What is claimed is:

1. A method for providing one or more user-centric wellness decision support services, wherein the method comprises:
providing an interface that facilitates selection of a risk assessment model of interest for a user and an action plan to trigger one or more follow-up action items;
applying the selected model to assess the user's wellness risk level based on one or more user wellness records; and
applying the selected action plan to trigger one or more relevant disease management and lifestyle interventions.

2. The method of claim 1, further comprising using a personal wellness knowledge manager to maintain a wellness knowledge repository.

3. The method of claim 1, further comprising using a personal wellness decision support client to facilitate sharing of disease management and lifestyle intervention action plans in an online knowledge repository.

4. The method of claim 1, further comprising using a wellness decision service deployment module to analyze input from a knowledge repository and one or more restrictions and constraints in a user risk profile, and output an adjusted plan.

5. The method of claim 1, wherein providing an interface further facilitates selection of a target population group with which to compare a personal risk level.

6. The method of claim 5, wherein applying the selected model to assess the user's wellness risk level based on one or more user wellness records further comprises assessing the user's wellness risk level based on records from the selected target population group.

7. The method of claim 1, further comprising providing a configuration-free module for use if there is no selection of a risk assessment model of interest and an action plan.

8. The method of claim 7, wherein the configuration-free module solicits input from one or more healthcare professionals and one or more users.

9. The method of claim 7, wherein the configuration-free module comprises an automatic profiling module that constructs a user's wellness profile by scanning through one or more user wellness records and identifying one or more risk factors.

10. The method of claim 7, wherein the configuration-free module comprises a user model solicitation interface that facilitates interaction with the user for input of one or more wellness management goals and risk factor importance.

11. The method of claim 7, wherein the configuration-free module comprises a configuration facilitation module that identifies one or more pertinent risk models and associated risk factors and ranks one or more relevant action plans.

12. The method of claim 11, wherein ranking one or more relevant action plans comprises information-based filtering by matchmaking a description of each action plan to one or more user records and aggregating an importance level rating of one or more involved risk factors.

13. The method of claim 11, wherein ranking one or more relevant action plans comprises collaborative filtering by aggregating an importance level rating of each risk factor from one or more users who have a similar wellness history to the user in question.

14. The method of claim 7, further comprising using a wellness decision service deployment module to analyze input from a knowledge repository and one or more restrictions and constraints in a user risk profile, and output an adjusted plan.

15. The method of claim 1, further comprising facilitating a vendor to subscribe to one or more models stored in a knowledge repository and generate one or more new wellness-related services for one or more target users based on the one or more learned models.

16. The method of claim 1, further comprising providing a system, wherein the system comprises one or more distinct software modules, each of the one or more distinct software modules being embodied on a tangible computer-readable recordable storage medium, and wherein the one or more distinct software modules comprise a personal wellness decision configuration interface module, a risk stratification engine module and a personalized recommendation engine module executing on a hardware processor.
